(19) United States
(12) Patent Application Publication
(10) Pub. No.: US 2011/0129784 A1
(43) Pub. Date: Jun. 2, 2011

(54) LOW THERMAL EXPANSION DOPED FUSED SILICA CRUCIBLES

(76) Inventors: James Crawford Bange, Corning, NY (US); Michael E. Collier, Corning, NY (US); David I. Seymour, Horseheads, NY (US); Ronald Leroy Stewart, Elmira, NY (US); Christopher L. Thomas, Corning, NY (US)

(21) Appl. No.: 12/952,877

(22) Filed: Nov. 23, 2010

Related U.S. Application Data
(60) Provisional application No. 61/265,133, filed on Nov. 30, 2009.

(51) Int. Cl. F27B 14/10; C03B 20/00; C03B 32/00; C04B 35/14; C04B 35/16; C04B 35/48

(52) U.S. Cl. 432/265; 65/17.6; 65/30.1; 501/133; 501/123; 501/103; 501/104; 501/121; 501/126; 501/127; 501/125

(57) ABSTRACT

The present disclosure relates to a silica-based crucible material that includes, before sintering or firing, selected amounts of a thermal expansion stabilizer component (B₂O3 and Ca2SiO₄) which impart improved thermal shock resistance and enhanced ability to withstand repeated thermal cycling, to a sintered or fired crucible made of the material. An illustrative embodiment of the invention provides a crucible material whose chemical composition comprises, in weight %, about 91% to about 98% SiO₂, about 1% to about 8% thermal stabilizer component, and up to about 1.0% of additional oxides including MgO, Al₂O₃ Fe₂O₃, CaO and ZrO₂.

### CROSS-REFERENCE TO RELATED APPLICATIONS

This application claims the benefit of priority under 35 U.S.C. §119(e) of U.S. Provisional Application Ser. No. 61/265,133 filed on Nov. 30, 2009.

### TECHNICAL FIELD

The present disclosure relates to crucibles, and methods forming the crucibles, for use in, calcining and purifying, among other materials, phosphate materials for use in fluorescent light bulbs. In particular, the disclosure is directed to silica crucibles which exhibit increased thermal shock resistance and reduced thermal volume change during sustained thermal cycling.

### BACKGROUND

Ceramic crucibles are known in the metal casting art for melting or holding a molten metal or alloy. An induction melting crucible typically includes a ceramic crucible around which an induction coil is disposed to heat and melt a solid metal or alloy charge. Holding or transfer crucibles are used to hold molten metal or alloy for a next operation, such as pouring, or to carry molten metal or alloy from one location to another. The ceramic crucible material typically comprises a mixture of ceramic components including a stabilizing component present to react with and at least partially stabilize a primary ceramic component of the mixture to reduce thermally-induced volume changes when the crucible is heated. For example, monoclinic zirconia (ZrO₂) undergoes a phase change at about 1000° C., which produces a large volume change in, and thus a thermal shock to, the material. This volume change/thermal shock often causes cracking and spallation, within a ZrO₂ crucible, thus reducing the useful life of the crucible. It is known that a stabilizing agent, such as MgO or Y₂O₃, has been included with the ZrO₂ to stabilize the monoclinic phase such that the phase change occurs over a much wider range of temperatures so as to reduce stresses in the crucible. Additional improvements in the thermal shock resistance of a sintered or fired zirconia-based crucible have been achieved through the use of a combination of MgO, SiO₂, and Y₂O₃ in selected amounts as components in the zirconia crucible.

High purity silica refractory material crucibles are known for use in calcining and/or purifying phosphate materials. In the case of phosphate powders, the raw uncalcined powders are placed in high purity silica crucibles and typically heated to temperatures, exceeding 1100° C. so as to calcine and purify the phosphate material; this calcining purifying step may be done under special atmospheres (such as Hydrogen and/or Nitrogen) which enhance the purification. Once completely calcined and purified the powder is thereafter cooled to room temperature, removed from the crucibles and processed for use in fluorescent light bulbs. The high purity silica crucibles are then reused a number of times to calcine additional amounts of phosphate powders. Although the reused high purity silica crucibles are capable of producing phosphate powders exhibiting sufficiently high purity, the typical use lifetime exhibited by the crucibles is on the order to a couple of thermal cycles; not acceptable by industry standards. Like the aforementioned Zirconia crucibles, these silica crucibles undergo repeated phase changes at 250° C., most likely the formation of a cristobolite phase, as a result of the thermal cycling to which the silica-based crucibles are exposed. These repeated phase changes which produce repeated large volume changes in the crucible material and a repeated thermal shock to the crucible typically induce cracks and subsequent crack propagation which ultimately leads to failure of the crucible; i.e., the crucibles exhibit low thermal shock resistance and/or thermal fatigue.

In view of the foregoing problems with current high purity silica crucibles, there is a need for crucible materials, for use in melting and/or holding high purity phosphate powders, which exhibit increased use lifetimes; i.e., crucible materials capable of withstanding numerous thermal (heating followed by cooling) cycles. In particular, there is a need for materials and crucibles for melting/calcining phosphate materials which exhibit reduced cracking, and thus an increased thermal shock resistance/thermal fatigue upon thermal cycling and thus are capable of repeated thermal cycling.

### SUMMARY

Disclosed herein is a high purity silica crucible which exhibits improved thermal cycling performance (i.e., increased thermal shock resistance) and which is particularly suitable for use in the calcining and purification of phosphate powders. More specifically, disclosed herein is a silica-based crucible material that includes, before sintering or firing, selected amounts of a thermal expansion stabilizer component. Sintered or fired crucibles made of this doped silica material exhibit improved thermal shock resistance as exhibited by an increased ability to withstand repeated thermal cycling.

An illustrative embodiment of the invention provides a crucible material whose chemical composition comprises, in weight %, of about 91% to about 98% SiO₂, about 1% to about 8% thermal stabilizer component, and up to about 1.0% of additional oxides including MgO, Al₂O₃, Fe2o3, CaO and ZrO₂. The thermal stabilizer component is a material which improves the thermal shock resistance and thermal fatigue of the crucible and is selected from the group consisting to B₂O₃ and Ca2SiO₄.

The method for forming the silica based crucible involves the steps of forming a silica based-slurry mixture which comprises in the mixture, between 1% to 8% by weight, as based on the fused silica, of a thermal stabilizer component material (B₂O₃ and Ca2SiO₄) calculated on the metal basis. Following mixing, the method involves drying the of silica-thermal stabilizer component-mixture to rigid silica fragments containing the thermal stabilizer component material oxide, and thereafter calcining the silica fragments at about 1150°-1500° C., and then firing said silica fragments to a fused silica product. When formed to a crucible shape and sintered (fired) at high temperature (e.g. above 1150° C.), the silica-based ceramic material provides a fired ceramic crucible with improved resistance to thermal shock, and increased ability to withstand thermal cycling, when heated in use for calcining or purifying phosphate powders at temperatures over 1100° C.

The above and other advantages of the present invention will become more readily apparent from the following detailed description.

### DETAILED DESCRIPTION

Disclosed herein is a silica-based crucible material that is especially useful for making crucibles which are used for calcining or purifying phosphate powders in air, under vacuum, or under a special/protective atmosphere such as inert gas, although the doped silica crucibles can be used for melting other metals and alloys that include, but are not limited to, steel, iron based alloys, and aluminum. Also sintered (fired) ceramic crucibles in accordance with the present disclosure exhibit improved resistance to thermal shock and increased ability to withstand thermal cycling, when heated in use for purifying/calcining phosphate powders over 1100 C.°. In particular, the phosphate powders purified using the improved crucibles are typically utilized in fluorescent lighting applications.

Pursuant to an illustrative embodiment of the invention provides a crucible material whose chemical composition consists essentially of, in weight %, before sintering, about 91% to about 98% SiO2, about 1% to about 8% of a thermal stabilizer component and, up to about 1.0% of additional oxides including MgO, Al₂O₃ Fe₂O₃, CaO and ZrO₂. The thermal stabilizer component is a material which improves the thermal shock resistance and thermal fatigue of the crucible and is selected from the group consisting to B₂O3 and Ca₂SiO₄. Furthermore, as a result of the inclusion of the thermal stabilizer component and the associated improvement in thermal shock resistance/thermal fatigue, the crucibles comprised of this doped fused silica material are capable of withstanding repeated thermal cycling. In one embodiment the crucibles are capable of withstanding at least 9 thermal cycles and in a still further embodiment the crucibles can withstand up to at least 20 thermal cycles.

A thermal cycle is measured in the following manner. First, a natural gas furnace large enough to accommodate at least six crucibles is preheated to 1160° C.; a crucible for measuring thermal cycling exhibits the following dimensions—a 4″ top outside diameter, a 3.25″ bottom outside diameter, 5″ top-to-bottom height and a ¼″ wall thickness. Prior to being inserted into the furnace the so-formed crucibles, which have been fired during formation to a temperature of at least 1250° C., are inspected for the lack of detectable flaws. Unheated, room temperature crucibles (up to six) are placed into the furnace using steel tongs. After a period of 2 hours the crucibles are removed from the furnace, placed on a shelf at room temperature and left to naturally cool. After 1 hour of cooling the crucibles are inspected using a lightbox to visually detect the presence of any cracks; additionally they are tapped with a steel bar to audibly check for the presence of cracks. If a flaw is found the crucible is rejected as having not passed a thermal cycle. If no flaws are found the crucible is then subject to additional thermal cycles until a detectable flaw(s) is found.

While not intending to be limited by theory, it is surmised that the thermal stabilizer component (B₂O₃ and Ca₂SiO₄) improves the thermal shock resistance and thermal fatigue of the crucible and the ability withstand repeated thermal cycling as a result of the minimization or inhibition of the growth of a β-cristobolite crystal phase which typically occurs when upon silica devitrification that occurs when silica-based crucibles (>90% silica by weight) are heated to temperatures exceeding 1100° C. Upon cooling the β-cristobolite crystal converts back into α-cristobolite at temperatures below about 300° C. Given that β-cristobolite does not exhibit the same thermal expansion coefficient α-cristobolite the silica crucible is prone to experience significant volume change which causes stress to the crucible leading to the formation of cracks. As the crucible is subject to thermal cycling, this volume change associated with the transformation between the two cristobolite phases leads to additional thermal expansion and volume changes which exacerbate the cracking; ultimately the crucible fails due this excessive cracking. That said, it is theorized that the inclusion of the thermal stabilizer component (B₂O₃ and Ca₂SiO₄) functions to improve the thermal expansion resistance or thermal fatigue in one of two ways; either the minimization/inhibition of the growth of a β-cristobolite crystal phase or the maintaining of the β-cristobolite crystal upon cooling (rather than the conversion back into the α-cristobolite form.)

Another unexpected benefit of the doped silica crucible is the combined ability to achieve sufficient and requisite outgassing during heatup during the phosphor calcining or purifying process, while still achieving the necessary, and compared to standard silica crucibles, improved sealing between the crucible and the crucible top at the purification hold temperature, typically occurring at or around 1160°. It should be noted that standard silica crucibles/crucible top configurations exhibit the requisite outgassing, but do not seal particularly well at the phosphor purification hold temperature. It should also be noted that it would be possible to pre-seal the crucible top prior to heatup for any crucible/crucible top material/configuration, however the necessary heat-up outgassing would not be allowed to happen. In the doped silica crucible disclosed herein, the inclusion of the stabilizer component/dopant material (e.g., B₂O₃) results in a crucible which exhibits a lower softening point and thus is better suited/more compatible with the sintering/calcining process. In other words, due to a better temperature match between the softening point and the calcining temperature, and thus a better seal, less oxygen is allowed to enter the calcining/purifying environment. As a result of this better combination sealing/outgassing feature, better quality/longer lifetime phosphor materials can be produced using these doped silica crucibles; i.e., the phosphor is capable of exhibiting a higher brightness when used in lighting applications. This should be contrasted with other materials which are capable of lowering the softening point (such as Na) which typically lead to undesirable devitrification which makes Na-doped crucibles unsuitable for phosphor calcining applications.

Pursuant to a second illustrative embodiment of the invention, the crucible material comprises about 91% to about 94% SiO₂, about 5% to about 8% of the thermal stabilizer component and, up to about 1.0% of additional oxides including MgO, Al₂O₃, Fe₂O₃, CaO and ZrO₂. Again, the thermal stabilizer component is a material which improves the thermal shock resistance, thermal fatigue of the crucible and enhanced ability to withstand repeated/numerous thermal cycling, and is selected from the group consisting to B₂O₃ and Ca₂SiO₄. In a related embodiment, the thermal stabilizer component comprises B₂O₃ in an amount ranging from 5.4% to about 7.4%, by weight.

Another exemplary crucible material comprises, in weight %, before sintering or firing, about 93% SiO₂, about 6% B₂O₃, and 1% of the additional oxides including MgO, Al₂O₃ and ZrO₂.

In general, the method for producing a high purity fused silica product comprises the following steps: (1) forming a liquid flowable silica slurry mixture comprising between about 1% to 8% by weight, as based on the fused silica, of a thermal stabilizer component material, calculated on the metal basis; (2) drying the silica-thermal stabilizer component mixture to form rigid silica fragments containing the stabilizer component material oxide; (3) calcining the silica fragments containing the stabilizer component material oxide at a temperature of about 1150°-1500° C., and then, (4) firing said silica fragments to form a fused silica product.

Any of the known sources of high purity silica may serve as a starting material for present purposes. These include, for example, hydrolyzed organosilicates, in particular ethyl silicates, hydrolyzed silicon tetrachloride, and an aqueous sol of fumed silica. Additionally, for purposes of the present disclosure, crushed high silica content glass can serve as the source of the silica component; for instance Vycor® glass which comprises 96.5% SiO₂, 2.50% B₂O₃, 0.50% ZrO₂, 0.20% other miscellaneous oxides, and 0.30% alkalis. The critical requirements are that the starting material have a requisite degree of purity, and be in the form of, or be capable of conversion to, a colloidal suspension in the nature of a silica sol or slurry.

The required amount of the thermal stabilizer component (either B₂O₃ and Ca₂SiO₄) material, in finely divided oxide form (e.g., boron oxide powder), is then added to, and dry mixed with, the silica material for a suitable time to form a homogenous dry mixture. A conventional ball mill available from US Stoneware (utilizing alumina media), or any other suitable dry mixer, can be used to this end. It has been found that while particle size is not critical, improved results are generally obtained with finer subdivision, and thus silica and thermal stabilizer component materials that either dissolve or that will pass through a 325 mesh screen (44 microns) should be utilized in the mixture. While we use the term “oxide”, this is intended to include any oxide precursor such as decomposable metal salts (e.g. nitrates or carbonates) and oxidizable elemental metals. It is also contemplated the B₂O₃ source boric can comprise acid powder.

The dry mixture then is mixed with the appropriate amount of water, for example, deionized water, for a suitable time to form a homogenous wet mixture having a desired water content. The wet mixture can then be further mixed in the ball mill mixer, or any other suitable mixer, can be used to mix the liquid and dry mixture to form the wet mixture.

The wet mixture then should then be passed through a vibratory SWECO separator 24 mesh (Tyler) screen (model No. 1S18S33 from Sweco, Inc. Los Angeles, Calif.) to remove agglomerates greater than 24 mesh (approximately 170 microns), permitting material finer than 24 mesh to pass through. The wet mixture then can be poured in conventional slip casting molding equipment to form a free-standing green (unfired) crucible body shape.

The so-formed molded crucibles can be then sintered at a high temperature of 1350° C. in air, preferably in the range of 1200 to 1350° C., to form a sintered (fired) crucible that exhibits improved thermal shock resistance/thermal fatigue and is ready for repeated thermal cycling that is typically exhibited in the calcining or purification of phosphate powders.

### EXAMPLES

### Examples 1-18

18 test crucibles were made pursuant to an illustrative embodiment of the invention and were formed in the following manner. Vycor® tubing cullet produced was run through a roller crusher to crush pieces smaller than 1″; the Vycor tubing cullet exhibited a composition comprising, by weight, 96.50% SiO₂, 2.50% B₂O₃, 0.50% ZrO₂, 0.20% miscellaneous other oxides, and 0.30% of mixture of alkalis. 150 lbs. of the Vycor cullet was placed into a US Stoneware mill which was filled ½ full of 1¼″ cylindrical alumina media. 4.5 lbs. of boron oxide (Alfa Aesar, 98.5% purity) was added to the mill. The mill was closed and allowed to run for 5 minutes to disperse the boron oxide among the glass due to the exothermic reaction that occurs when the water is added. 40 lbs. of 1 MHz deionized water was added to the mill. The mill was then allowed to run until the amount of particles left on a US Standard 325 mesh screen was between 2 to 4 ml after it was tapped on a S-TAV 2003 Stampfvolumeter (Jel) unit for 500 taps.

The resultant slip was then poured out of the mill through a 35 mesh screen to remove any large particles not crushed in the milling process. The slip was placed on rollers in SOL Nalgene jugs to cool overnight while keeping the particles dispersed in the water.

Plaster of Paris molds were used for the slip casting process. The molds were lightly scrubbed using a abrasive scrub pad and sprayed with a corn starch and water mixture which is used as a release agent. The slip was gradually poured into the mold in the following manner. An initial amount of the slip was poured into the mold and as time progressed and the water was absorbed into the mold (i.e., the level of slip dropped below it's initial level), more slip was added to maintain the original fill level. This slip addition process continued until the crucible wall thickness had built up to the desired thickness; typical thicknesses achieved varied between ¼″ to ½″.

Once the proper crucible thickness was achieved each of the crucibles were allowed to set (in the mold) for a period of 15 minutes so as to allow the green/wet crucibles to achieve the necessary green strength. The so-formed wet/green crucibles were then removed from the mold by utilizing an air hose; specifically, compressed air was blown between the crucible and the mold to release the crucible. The top edges of the crucibles were then green finished with water and an abrasive pad or alternatively trimmed using a saw for achieving a flat edge (for those crucibles which will be used with covers.

The so-formed green crucibles were then dried at RT conditions for at least 2 days before firing. The crucibles were then loaded in a 28″×40″×50″ gas fired box furnace. The crucibles were then fired to a temperature of 1250 or 1350° C. with no hold time and the furnace was then shut off and the crucibles were then allowed to cool back down to RT; the entire firing and cooling cycle taking approximately two days. The resultant, as analyzed, composition of the so-formed crucibles, both as-fired (As-fired) and following thermal cycling (Post-thermal cycling), is reported in Table I; the composition of one of the crucibles was measure and is deemed to be representative of all those formed utilizing the same batch and forming procedure described above. Chemistry results have some level of error associated with the measurement of the elements present and thus compositions are listed as ranges to account for measurement error. With quantities between 3 wt % and 100 wt % the error is estimated at 1%. Since SiO₂ has such high values at >90% this makes it the source of most of the error in the chemistry measurements ((±0.9%) as is the main cause for why the chemistry totals do not add to 100%. Additionally, it is should be noted and is theorized that the compositional change between as-fired and post-thermal cycling for the representative crucible is likely due to small amounts of B₂O₃ volatizing off during subsequent thermal cycles. Finally, it should be noted that the source of the Al₂O₃ is now present in the analyzed due to the alumina grinding media.

TABLE I

| Sample | SiO₂ (%) | B₂O₃ (%) | Al₂O₃ (%) | ZrO₂ (%) | Ca (ppm) | Na (ppm) | Ti (ppm) |
|---|---|---|---|---|---|---|---|
| 1-18 As-fired | 92.0-93.8 | 5.36-5.46 | 0.52-0.64 | 0.5 | 60-140 | 52.8-123.2 | 16.2-37.8 |
| 1-8, Post-thermal cycling | 92.3-94.1 | 4.91-5.01 | .21-.25 | 0.5 | 38.4-89.6 | 66-154 | 16.2-37.8 |

Eighteen of the so-formed/resultant crucibles were then subjected to thermal cycling conditions (described above in detail) in the following manner. The so-formed crucibles were placed in a furnace and heated to temperatures in excess of 1250° C. for a period of 1 hr. and then cooled to RT and repeated until defects were detected in the crucibles. It is reported in Table II that these boron-doped silica crucibles exhibited increased thermal shock resistance/thermal fatigue as evidenced by the fact that all 18 crucibles were able to withstand in excess of 20 thermal cycles; 5 of the so-formed crucibles actually exceeded 50 cycles.

TABLE II

| Sample ID | Thermal Cycles |
|---|---|
| 1 | 21 |
| 2 | 35 |
| 3 | 36 |
| 4 | 41 |
| 5 | 28 |
| 6 | 22 |
| 7 | 29 |
| 8 | 35 |
| 9 | 47 |
| 10 | 76 |
| 11 | 45 |
| 12 | 78 |
| 13 | 39 |
| 14 | 38 |
| 15 | 51 |
| 16 | 62 |
| 17 | 28 |
| 18 | 59 |

### Examples 19-20

Two additional crucible examples were formed, and thermally cycled, with both being formed from batch mixtures comprising pure silica powder and boric acid powder. The batch mixture from which each crucible was formed comprised 150 lbs. of pure fused silica powder; particularly GG-4+50 AW, −4 mesh and +50 mesh, fused silica powder as marketed by the Mineral Technology Corporation, Keystone, S. Dak. For the first crucible batch mixture, 4% by weight boric acid (6 lbs.) was added, while the second crucible batch mixture was batched with 5.4% (8.1 lbs.) of the same boric acid source; particularly, Optibor® TG −20 Mesh, as marketed by the Borax Corp.

In both cases the same procedure as described above was used to form the crucibles; particularly ball mill mixing, slurry formation, slip casting, green finishing, drying and then firing at 1250° C. Again, as before the final composition of the crucible would include, in addition to the SiO₂ and B₂O₃ constituents, approximately 0.5% Al₂O₃ as a result of the alumina grinding media utilized in the ball mill

At least one crucible from each batch was subjected to thermal cycling procedure described above. It is reported in Table II that these boron-doped silica crucibles again exhibited increased thermal shock resistance/thermal fatigue as evidenced by the fact that both crucibles were able to withstand numerous thermal cycles; 17 and >22 thermal cycles respectively.

TABLE III

| Sample | B₂O₃ Amount | Thermal Cycles |
|---|---|---|
| 19 | 4 | 17 |
| 20 | 5.4 | >22 |

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

We claim:

1. A crucible material comprising, in weight %, before sintering or firing, of about 91% to about 98% SiO₂, about 1% to about 8% of a thermal expansion stabilizer component, and up to about 1.0% other miscellaneous oxides.

2. The crucible material of claim 1 wherein the thermal expansion stabilizer component comprises B₂O₃ or Ca₂SiO₄.

3. The crucible material of claim 2 wherein the other oxides comprise an oxide selected from the group consisting of ZrO₂, MgO, Fe₂O₃, CaO and Al₂O₃.

4. The crucible material of claim 1 comprising, in weight %, before sintering or firing, of about 91% to about 94% SiO₂, about 5% to about 8% of the thermal expansion stabilizer component, and 1% of other miscellaneous oxides.

5. The crucible material of claim 4 wherein the thermal expansion stabilizer component is B₂O₃ and is present in ranges between about 5.4% to about 7.4%, by weight.

6. The material of claim 1 comprising in weight %, before sintering or firing, of 93% SiO₂, 6% B₂O₃ and 1% of the combination of other miscellaneous oxides.

7. A crucible made from the crucible material of claim 1.

8. The crucible of claim 7 which is capable of withstanding at least 9 thermal cycles.

9. The crucible of claim 7 which is capable of withstanding at least 20 thermal cycles.

10. A method for producing a high purity fused silica product which comprises the steps of producing a liquid flowable silica-based slurry mixture comprised of between 1% to 8% by weight, as based on the fused silica, of a thermal stabilizer component material, calculated on the metal basis, drying the silica-thermal stabilizer component mixture to rigid silica fragments containing the thermal stabilizer component material oxide, calcining the silica fragments containing the thermal stabilizer component at about 1150°-1500° C., and then firing said silica fragments to a fused silica product.

11. A method in accordance with claim 8 wherein the thermal stabilizer component material is B₂O₃ or Ca₂SiO₄.

12. The method of claim 11 wherein the thermal stabilizer component material comprises B₂O₃ and the source of the boron oxide powder, boron acid powder or mixtures thereof.

13. A method in accordance with claim 9 wherein the thermal stabilizer component material is added in amounts between 5-8%.

14. A method in accordance with claim 8 wherein the calcined product is milled to form a slip which is cast in a mold and the product thus formed is fired to a fused silica body of corresponding shape.
